(19) United States
(12) Patent Application Publication
(10) Pub. No.: US 2016/0047098 A1
(43) Pub. Date: Feb. 18, 2016

(54) SYSTEMS AND METHODS OF ELEVATED DRAINAGE FOR FLOOD CONTROL AND WATER CONSERVATION

(71) Applicant: Jackie B. Hontiveros, San Mateo, CA (US)

(72) Inventor: Jackie B. Hontiveros, San Mateo, CA (US)

(21) Appl. No.: 14/460,343

(22) Filed: Aug. 14, 2014

(51) Int. Cl. E02B 1/02; F17D 1/14; F17D 3/01; C02F 1/00

(52) U.S. Cl. CPC E02B 1/02; C02F 1/008; F17D 1/14; F17D 3/01; C02F 2103/001

(57) ABSTRACT

The present invention relates to systems and methods for cost effectively supplementing existing networks of ground/underground-level drainage pipes with a system of elevated pipes, by leveraging existing elevated transportation and communications infrastructure while minimally disrupting existing water drainage infrastructure.

### BACKGROUND

The present invention relates to systems and methods for improving flood control by the use of elevated pipes, thereby supplementing existing water draining systems of urban areas.

In many urban areas, especially low-lying tropical/sub-tropical flood-prone areas, such as the sprawling city of Manila, every rainy season brings severe rainstorms and the resulting floods when the volume of rainfall far exceeds the capacity of the existing water drainage system, consisting mostly of ground level and underground drains and pipes. While it is technically feasible to replace or substantially increase the capacity of these existing drainage systems of urban metropolitan areas, budgetary constraints/overruns and the disruptions caused such massive infrastructure projects are prohibitive.

As a result, daunting obstacles and challenges must be overcome to be able to enhance inadequate flood water removal systems in many built-up urban areas where typically antiquated and deteriorated underground flood control systems have been brought about by urban sprawl and haphazard inadequate planning and maintenance over many years. These include prohibitively large expenses associated with renovating and expanding underground flood water removal systems due to, for example, the need to excavate under existing built-up structures such as roadways, and public, commercial and residential structures. Other challenges include the cost of acquiring property through which to channel underground piping for expansion of existing flood water removal systems. Another big challenge is the massive disruption of traffic flow during the construction of flood water removal facilities.

Hence, most cities, for a variety of political and fiscal reasons, elect to live with existing inadequate water drainage systems, and only make minor and modest improvements from time to time. Consequently, as evidenced by news reports, whenever very heavy rainfall occurs, e.g., during typhoons and hurricanes, flood-prone cities around the world frequently endure massive floods and the resulting deaths and damage to property.

It is therefore apparent that an urgent need exists for systems and methods for supplementing existing water drainage system that are both cost-effective and less disruptive to install. These improved drainage systems should enable flood prone cities to substantially reduce the human suffering and property damage associated with reoccurring massive floods.

### SUMMARY

To achieve the foregoing and in accordance with the present invention, systems and methods for flood control is provided. In particular the systems and methods for cost effectively supplementing existing inadequate network of ground-level and underground-level drainage pipes are provided.

In one embodiment, a supplemental computerized flood control system includes a computerized flood control center, a network of elevated drainage pipes, a plurality of water flow sensors and a plurality of water pumps. The flood control center can be configured to control the existing network of ground-level and underground-level drainage pipes.

In this embodiment, the network of elevated drainage pipes is coupled to and controlled by the flood control center. The elevated pipes can also be coupled to the network of existing ground-level and underground-level drainage pipes. The network of elevated pipes include drainage pipes having a variety of diameters depending on the location and expected water drainage capacity. The plurality of water flow sensors is operatively coupled to the control center via a communication network. Some of the water flow sensors are located proximate to the network of ground-level and underground-level drainage pipes and the network of elevated pipes. Some of the pumps are controlled by the control center and are configured to pump flood water from the ground and underground levels to the elevated drainage pipes.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is a top view illustrating a flood control system in a flood prone area, in accordance with some embodiments of the present invention;

FIG. 2 is a perspective view of a rail right-of-way including an elevated pipe configured to transfer flood water, in accordance with the embodiment of FIG. 1;

FIGS. 3 and 4 are cross-sectional views of two roadway embodiments configured to transfer water via elevated pipes; and

FIG. 5 is a cross-sectional view of an Archimedes pump configured to pump water into the elevated pipeline.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The present invention relates to systems and methods for cost effectively supplementing existing networks of ground/underground-level drainage pipes with a system of elevated pipes, by leveraging existing elevated transportation and communications infrastructure while minimally disrupting existing water drainage infrastructure.

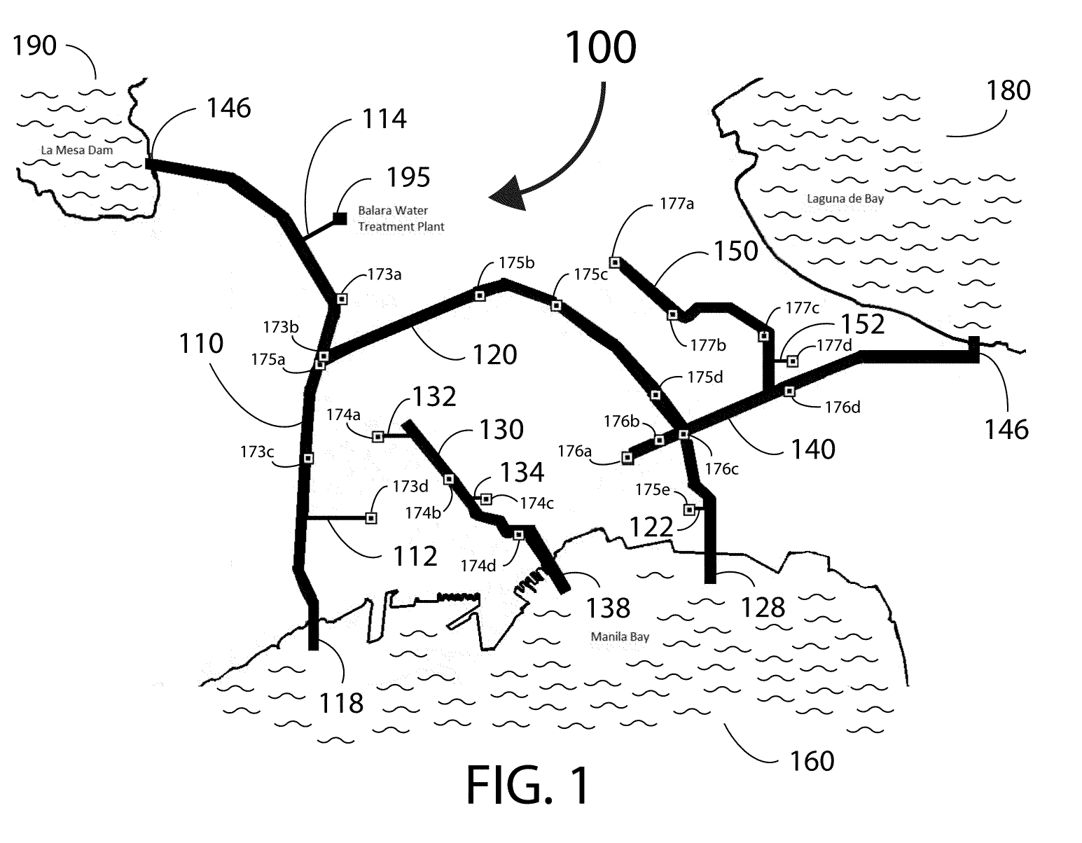

To facilitate discussion, FIG. 1 shows a top view of a typical low-lying metropolitan city, e.g., Manila, illustrating an exemplary embodiment of the elevated flood control system 100 in accordance with the present invention.

In this embodiment, flood control system 100 includes one or more computerized flood control center(s) (not shown) and a network of elevated drainage pipes (partially shown). The flood control center(s) can also be configured to control an existing network of ground-level and/or underground-level open drains and/or drainage pipes (not shown). Some of the flood control center(s) can be independently operated or operatively coupled to each other via public and/or private wide area network(s). The elevated pipes of flood control system 100 can also be coupled to the existing network of drains and pipes.

The network of elevated drainage pipes of flood control system 100 is configured to strategically serve low-lying areas and corresponding pumping locations, e.g., pumping locations 173a-173d, 174a-174d, 175a-175e, 176a-176d, and 177a-177d. One or more of the pipes and/or pumps can be coupled to and controlled by the flood control center. Flood control system 100 includes a backbone comprising of one or more large arterial elevated pipes, e.g., arterial pipes 110, 120, 130, 140 & 150, that can be for example approximately 10 to 20 feet in diameter and located at about 15 to 25 feet above street level. Ideally the pathways of the arterial pipes of flood control system 100 should be oriented so that they are appropriately sloped and are able to drain naturally under gravity. In some embodiments, one or more of the arterial pipes are substantially level and hence capable of draining water bi-directionally, i.e., reversibly.

In addition, these arterial pipes of flood control system 100 should ideally be located along existing arterial transportation/communication/utilities routes, especially elevated routes, so as to leverage the existing infrastructure, including railways, roadways, waterways, bridges, communication towers, electrical transmission towers, and elevated gas/oil pipeline supports. Additional advantages of co-locating with communications and/or utility infrastructure is the convenience of being able to cost-effectively tap into these communication channel(s) and/or power source(s).

The network of elevated pipes of flood control system 100 can have a variety of diameters depending on the location and expected flood water drainage demand. Hence, the arterial pipes of flood control system 100 can in turn fed by smaller secondary elevated pipes, e.g., secondary pipes 114, 122, 132, 134 & 152, and are approximately 5 to 15 feet in diameter. Ideally, secondary elevated pipes of flood control system 100 can be located at about 30 to 50 feet above the ground level, i.e., higher elevation relative to the arterial pipes, so that flood water from the secondary pipes can drain naturally into the arterial pipes of flood control system 100 under gravity.

For example, as illustrated by FIG. 1, elevated arterial pipe 110 connects La Mesa Dam Reservoir 190 to Manila Bay 160 via pipe outlet 118, elevated arterial pipe 130 and secondary pipe 132 connects Marikina City 174a to Manila Bay 160 via pipe outlet 138, and arterial pipe 140 connects Laguna de Bay 180 to Manila Bay 160 via pipe outlet 128.

Hence, by coupling large existing water catchment areas and/or water treatment facilities, such as lakes, reservoirs and water purification plants, to open waterways, such as bays, seas and oceans, e.g., Balara Water Treatment Plant 195 to Manila Bay 160, flood control system 100 has the ability to preemptively increase the capacity of these water catchment areas by anticipatory purges prior to predicted heavy rainfall, such as typhoons and hurricanes. Note that selected sections of arterial pipes 110, 120, 130, 140 and 150 can be level and/or directionally reversible, and hence able to transfer water to and from, for example, La Mesa Dam and Laguna de Bay. Such water conservation preserves fresh water for future use, e.g., during dry seasons and droughts.

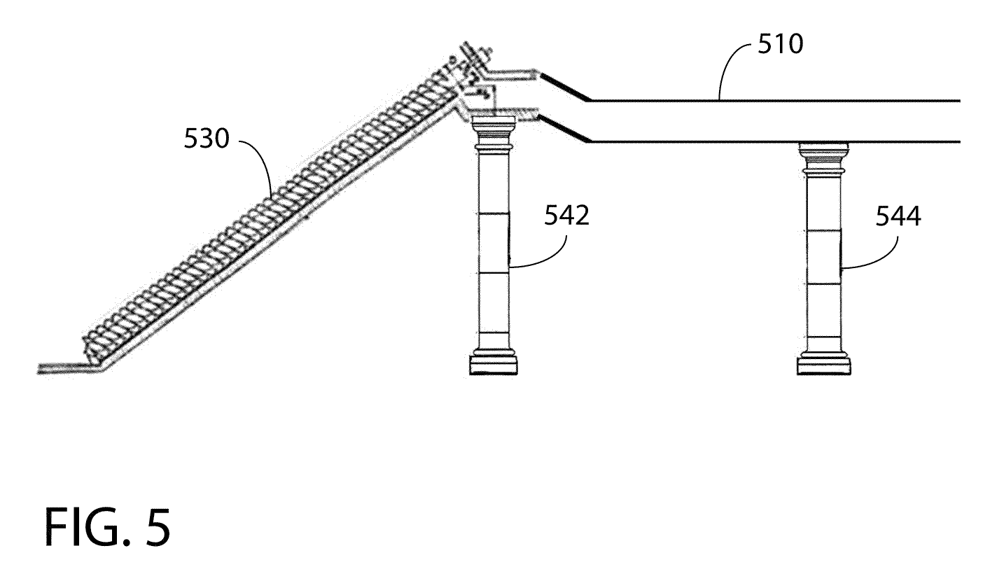

Hence, in most embodiments, flood control system 100 includes a plurality of pumps and/or valves to enable flood control system 100 to move and/or store flood water more efficiently, quickly and/or up gradients. Optional booster pumps may also be employed in some sections of system 100 which are extended and/or inclined. Some of these pumps/values can be controlled the flood control center(s) and the pumps can be configured to pump flood water from the ground/underground levels to the elevated drainage pipes and water storage facilities. These pumps can also be enhanced/protected by debris barriers. Suitable pumps for enhancing flood control system 100 include screw pumps, e.g., Archimedes pump 530 configured to pump water from ground level to elevated pipe 510, as illustrated by FIG. 5. Other exemplary pumps include centrifugal pumps, submersible pumps, jet pumps and/or turbine pumps.

In some embodiments, flood control system 100 also include a plurality of sensors, such as water flow sensors and cameras (not shown) operatively coupled to the flood control center, thereby increasing the functional capability of flood control system 100. Some of these sensors can be located proximate to the network of elevated pipes and/or the existing network of ground-level and underground-level drainage pipes. Other sensors can be located proximate to water catchment areas and/or transportation routes.

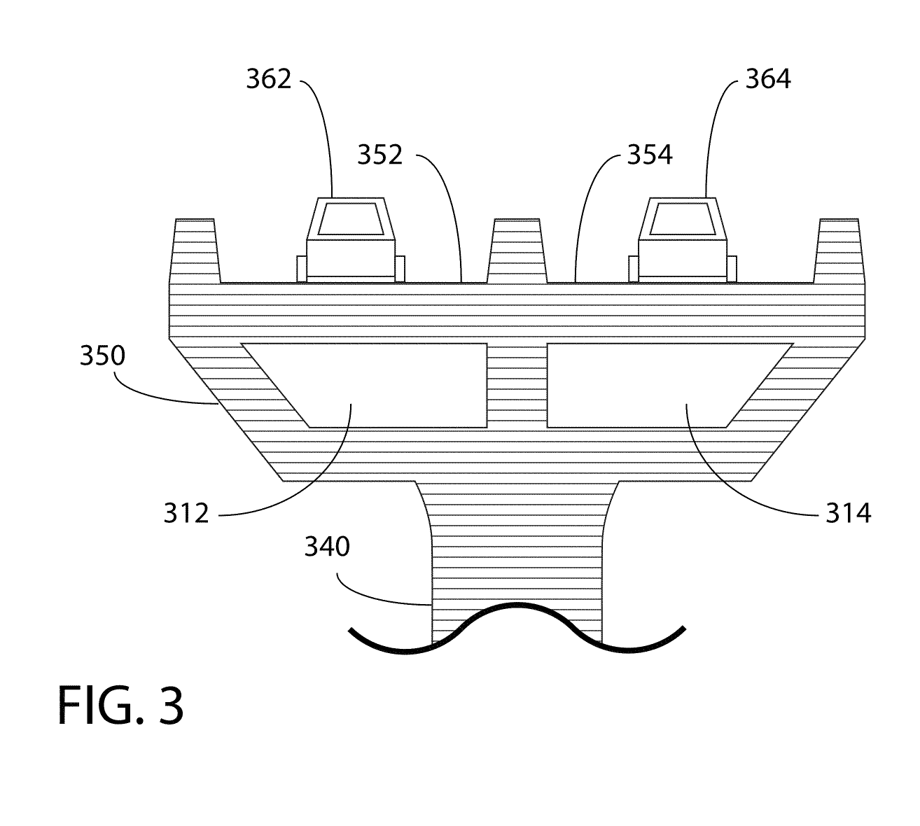

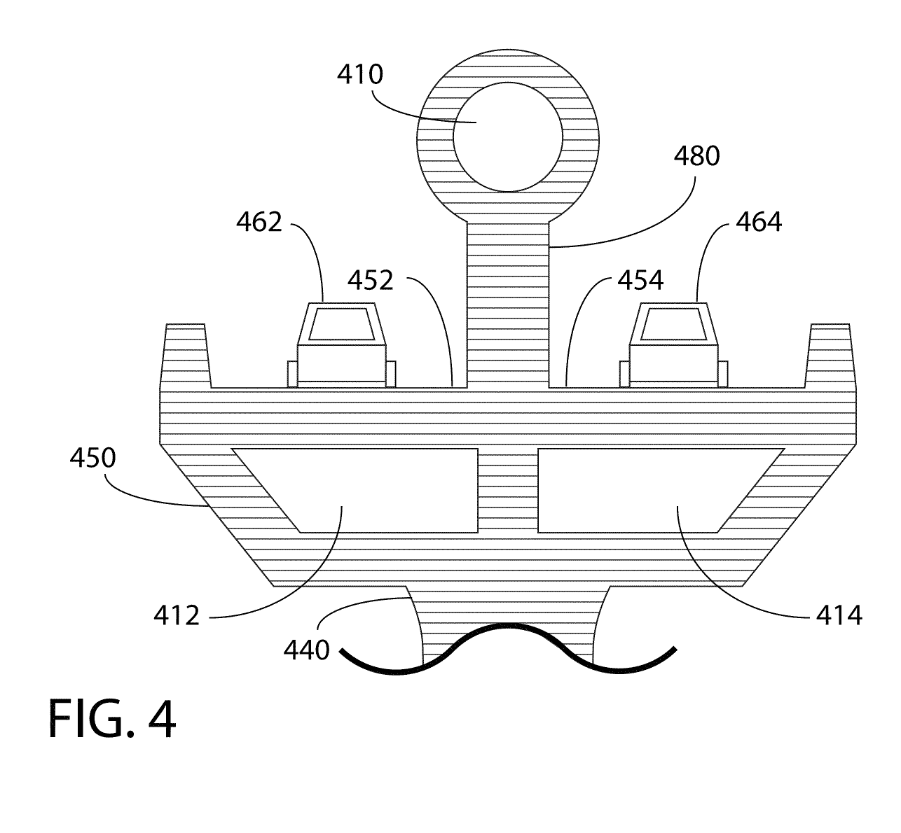

Modifications and additions to exemplary flood control system 100 are possible in accordance to the present invention. For example, as shown in FIGS. 3 and 4, since many existing elevated transportation roadways and train tracks are often supported by hollow reinforced concrete support structures, in some embodiments, these existing hollow support structures, e.g., hollow structures 312, 314 of roadway 350 and structures 412, 414 of roadway 450, can also be configured/reconfigured for double-duty, i.e., to also carry flood water, thereby substantially reducing construction costs, construction completion time and also minimizing political, socioeconomic, geological and esthetics impact. In some embodiments, pipes are laid inside these hollow structures 312, 314, 412, 414 for the specific purpose of transferring water.

It is also possible to supplement the arterial pipes and/or secondary pipes with speed moderators and/or configurations. For example, water flow speed in these pipes can be moderated adding substantially vertical loops, “zig-zags”, constrictions, and/or mechanical braking devices such as baffles to these elevated pipes.

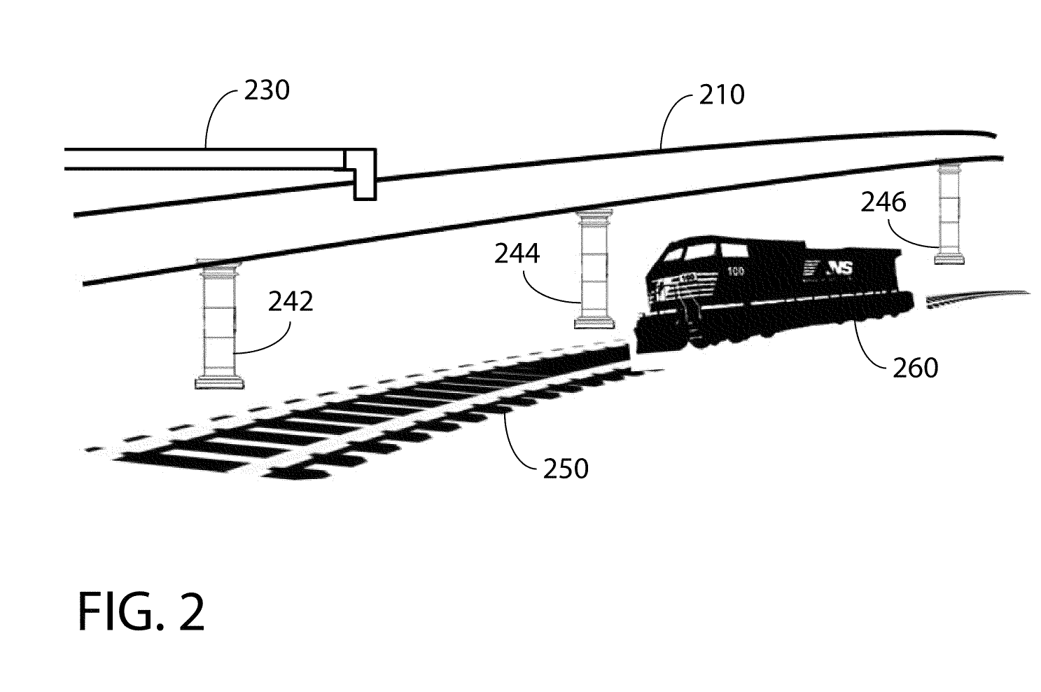

As illustrated by FIGS. 2 and 4, transportation right-of-ways such as railway 250 and elevated roadway 450 can also be modified to accommodate elevated pipes, e.g., pipes 210 and 410, respectively. Depending on the terrain, sections of these elevated pipes can be level and/or sloped, and capability supplemented by pumps and/or valves.

It is also possible to harness the energy from the flood water flow to generate mechanical and/or hydroelectric power, which can then be used to energize the pumps and sensors of flood control systems described above. The ability to supply/supplement power remotely to these pumps is particularly helpful when existing power transmission lines are disrupted/disabled by fast moving water or high winds or other natural disasters such as landslides and earthquakes. Another potential benefit of tapping power from the flood water flow is the reduction in the water flow rate and related destructive potential of the otherwise faster moving flood water.

While this invention has been described in terms of several embodiments, there are alterations, modifications, permutations, and substitute equivalents, which fall within the scope of this invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A computerized flood control system configured to supplement a network of ground-level and underground-level drainage pipes, the flood control system comprising:
a computerized flood control center operatively coupled to an existing water drainage network including at least one of a ground-level drainage pipe and an underground-level drainage pipe;
a network of at least one elevated drainage pipe operatively coupled to the flood control center and to the existing water drainage network, the network of at least one elevated drainage pipe including:
an arterial sub-network including at least one arterial drainage pipe having a first diameter; and
a secondary sub-network operatively coupled to the arterial sub-network, and wherein the secondary sub-network includes at least one secondary drainage pipe having a second diameter larger than the first diameter;
a plurality of water flow sensors operatively coupled to the control center via a communication network, and wherein some of the plurality of sensors are located proximate to the existing water drainage network and the network of at least one elevated drainage pipe; and
a plurality of pumps operatively coupled to the control center via the communication network, and wherein the plurality of pumps are configured to pump flood water to the network of at least one elevated drainage pipe.

2. The flood control system of claim 1 wherein some of the plurality of pumps are configured to pump flood water between the existing water drainage network and the network of at least one elevated drainage pipe.

3. The flood control system of claim 1 wherein at least a portion of the network of at least one elevated drainage pipe is supported by existing elevated infrastructure.

4. The flood control system of claim 3 wherein the existing elevated infrastructure is a part of an existing transportation infrastructure.

5. The flood control system of claim 1 wherein some of the flood water from the elevated plurality of pipes are diverted into water storage infrastructure.

6. The flood control system of claim 5 further comprising a plurality of valves configured to divert the flood water.

7. The flood control system of claim 6 wherein the water storage infrastructure includes at least one reservoir and the plurality of valves are further configured to divert the flood water to or from the at least one reservoir.

8. The flood control system of claim 5 wherein the some flood water from the network of at least one elevated drainage pipe is processed prior to being diverted into the water storage infrastructure.

9. The flood control system of claim 5 wherein the processing of the some flood water from the at least one elevated drainage pipes includes filtration.

10. The flood control system of claim 1 wherein the plurality of pumps includes at least one of a screw pump, a centrifugal pump, a submersible pump, a jet pump and a turbine pump.

11. The flood control system of claim 1 wherein at least a portion of the network of at least one elevated drainage pipe is incorporated into transportation infrastructure.

12. The flood control system of claim 11 wherein the incorporated transportation infrastructure include hollow reinforced concrete structures configured to carry flood water.

13. The flood control system of claim 1 further comprising at least one generator configured to energize at least one of the plurality of pumps.

14. The flood control system of claim 13 wherein the at least one generator is proximate to the existing water drainage network and configured to generate hydroelectric power from water flowing through the existing water drainage network.

15. The flood control system of claim 1 wherein the network of at least one elevated drainage pipe includes at least one speed moderator.
